(19) United States
(12) Patent Application Publication
(10) Pub. No.: US 2009/0159484 A1
(43) Pub. Date: Jun. 25, 2009

(54) BAG STACK WITH NO REMAINING WASTE

(76) Inventors: Armin MEYER, Koeln (DE); Jakob Schneider, Niederkassel (DE)

Correspondence Address: Muncy, Geissler, Olds & Lowe, PLLC, P.O. BOX 1364, FAIRFAX, VA, 22038-1364, US

(21) Appl. No.: 12/345,106

(22) Filed: Dec. 29, 2008

Related U.S. Application Data
(63) Continuation of application No. PCT/EP2007/004654, filed on May 25, 2007.

(30) Foreign Application Priority Data
Jun. 26, 2006 (DE) 10 2006 029 561.7

(51) Int. Cl. B65D 25/00; B31B 49/00

(52) U.S. Cl. 206/554; 493/341

(57) ABSTRACT

The invention relates to a bag-stack and a device for the production of bag-stacks, in particular bags for automated machines, wherein the bag stack is formed from a plurality of connected bags made of plastic foil, and wherein each bag is formed from a front wall and a back wall. The back wall is built longer than the front wall in the area of an opening. The bag stack is welded at the back wall to the longer end of the front wall, wherein the bag-stack exhibits at least three welds, distributed over the width of the bag stack at the longer end of the back wall in such a way that a sturdy edge of the bag-stack is formed.

This nonprovisional application is a continuation of International Application No. PCT/EP2007/004654, which was filed on May 25, 2007, and which claims priority to German Patent Application No. 10 2006 029 561.7, which was filed in Germany on Jun. 26, 2006, and which are both herein incorporated by reference.

### BACKGROUND OF THE INVENTION

1. Field of the Invention

The invention relates to a bag stack having a plurality of connected bags made of a plastic film, in particular bags for automatic dispensers, wherein each bag is composed of a front wall and a back wall, and the back wall is designed to be longer than the front wall in the region of an opening, and the bag stack is heat-sealed at the back wall and at the end that is longer than the front wall. The invention also concerns a device in a bag manufacturing machine for cutting apart bag stacks, in which the severing knife is movable relative to the bag stack.

2. Description of the Background Art

It is generally customary nowadays for supermarkets, for example, to make bags available to consumers for packing fresh foodstuffs. The bags are provided here in the form of bag stacks, wherein the bags are heat sealed or interconnected into a stack.

A bag stack of this nature is described in DE 199 35 064 A1. Described here is a stack of a plurality of joined bags made of plastic film, which have perforated corner sections delimited by perforation lines in a one-sided flap, with an interconnection point located in the vicinity of each corner section. This makes it possible to separate the individual bags from the interconnection points at the perforation. A disadvantage here is that a so-called leftover stub, namely the region where the bag stack was interconnected, remains as waste.

Another possibility for making bag stacks is described in Utility Model DE 47 29 628. Described here is a stack of bags made of thermoplastic material, which has, in one or both corner regions of the stack at the opening side of the bags, one or more heat seal points encompassing all bags, along with a suspension hole. Described in one exemplary embodiment of the utility model is a bag stack that has only a small remaining stub, or possibly none, by the means that the bag stack is heat sealed at the side edges that meet at right angles.

### SUMMARY OF THE INVENTION

It is therefore an object of the present invention to provide a bag stack that overcomes the disadvantages of the prior art and provides a bag stack that is stable for handling, easy to manufacture, and simply constructed by design. It is an additional object of the invention to provide a device in a bag manufacturing machine which can be used to produce an inventive bag stack.

In an embodiment, the bag stack has, distributed across its width, at least three heat seal points at one end of the back wall of the bag stack, so that a stable bag stack edge is formed. The inventive design of the bag stack now makes it possible to handle the bag stack easily, since the edge is stabilized due to the repeated heat sealing of the edge of the bag stack, so that the edge can be grasped easily and can also be positioned property. It is especially advantageous here to apply the heat seal points at regular intervals between the heat seal points at the edge of the bag stack. Applying the heat seal points at a distance from the longitudinal sides of the bag at the bag stack edge, along with a centered heat seal point, for example, makes it possible to align the bag stack precisely, since the bag stack has a right-angled contour in its corner regions, because the corners of the bag stack are not deformed by a heat seal. In its simplest embodiment, the inventive bag stack thus has a longer back wall as compared to the front wall, and has a fill opening, which is also referred to as a flap, while the bag stack is provided with two edge seal points a distance from the lateral edge of the bag stack, and with a centrally placed heat seal point. In addition, it is of course also possible to provide the bags in the bag stack with suspension holes and/or predefined breaking points, such as perforations as are known from the prior art, and/or bottom folds and/or side folds and/or flaps.

It is a further object of the invention to provide a bag manufacturing machine with a device in which an inventive bag stack can be produced easily and economically and with the least possible design effort. In addition, the device should be easy to integrate in existing bag manufacturing machines. Such bag manufacturing machines, which are provided with at least one severing knife for cutting apart twin bag stacks, are generally known. DE 199 17 284 is referenced here merely by way of example, and is incorporated herein by reference.

The object with respect to the device in a bag manufacturing machine for cutting apart twin bag stacks is attained according to the invention in that strips made of a material with a high thermal conductivity are attached to the severing knife at a distance from one another, and in that the severing knife and/or each strip is heated. The inventive attachment of strips of high thermal conductivity to the severing knife now makes it possible to heat-seal bag stacks to one another immediately during separation from twin stacks. Since the existing severing knives can be used for this purpose, as they need to be modified only slightly, the device can be produced economically and with a minimum of design effort. Preferably, copper is used as the material for the strips, since copper has very high thermal conductivity.

In an embodiment, the strips can be designed with a point in the direction of the cutting edge of the severing knife. In this context, “with a point” means that the strips with a rectangular cross-sectional shape are attached to the severing knife parallel to the severing knife, and that the rectangular cross-sectional shape tapers to a point in the direction of the cutting edge of the severing knife. Preferably, an angle of 30° is desired. It is also possible to design the top end of the strip with a trapezoidal shape, so that wider heat seal points can be achieved. In another advantageous embodiment, the pointed strip is beveled, which is to say that the thickness of the rectangular strip narrows toward the cutting edge of the severing knife, preferably at an angle of approximately 10°. Moreover, it is advantageous to attach the strips to the severing knife with a distance from one another of approximately 100 mm, and even more advantageous with a distance of 95 mm. The separation here refers to the tips of the strips. Alternatively, the strips can be attached to the severing knife at distances from 20 mm to 200 mm.

The Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a three-dimensional view of a twin bag stack;

FIG. 2 is a side view of a severing knife in a bag manufacturing machine, and

FIG. 3 is a section along line III-III as well as inventive strips in top view and in side view.

### DETAILED DESCRIPTION

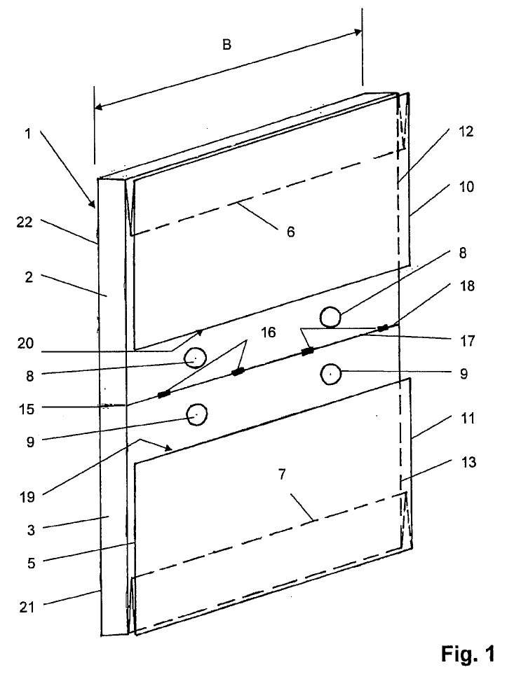

FIG. 1 shows a twin bag stack 1 having a first bag stack 2 and a second bag stack 3. The bag stacks 2, 3 includes a plurality of bags arranged on top of one another that are made of a plastic film. Only the bag 4, 5 constituting the top film section is shown raised above the bag stack 2, 3 for the purpose of clarity. In this embodiment, the bags 4, 5 are provided with a bottom fold 6, 7. In addition, suspension holes are placed in the bag stacks 2, 3. The bags 4, 5 of the bag stacks 2, 3 have a front wall 10, 11 and a back wall 12, 13. The back walls 12, 13 are designed longer with respect to the front walls 10, 11. The bags 4, 5 are composed of a folded section of film, so that the back walls 12, 13 are made of a layer of film. The film layers composed of the back walls 12, 13 of the bags 4, 5 are cut in the region of the separating line 15 by means of a severing knife 14, so that two separate stacks of bags 2, 3 are formed. The heat seal points 16 at the end 17, 18 of the bag stacks 2, 3 are formed by the cutting of the twin bag stack 1 with an inventive severing knife 14. Stable ends 17, 18 of the bag stacks 2, 3 are formed by the cutting of the twin bag stack 1 and the formation of heat seal points 16, which takes place uniformly across the width B of the bag stacks 2, 3. Such reinforced bag stacks 2, 3 are very easy to handle and position.

In this example embodiment, a fill opening is formed between the front wall 10, 11 and the back wall 12, 13. The bags 4, 5 are closed along their longitudinal sides 21, 22, while they are heat-sealed in the region of the front wall 10, 11 and the back wall 12, 13. The example embodiment shown in FIG. 1 is provided with bottom folds 6, 7 and suspension holes 8, 9. However, this is only by way of example, since predefined breaking points, side folds, and/or flaps may also be provided.

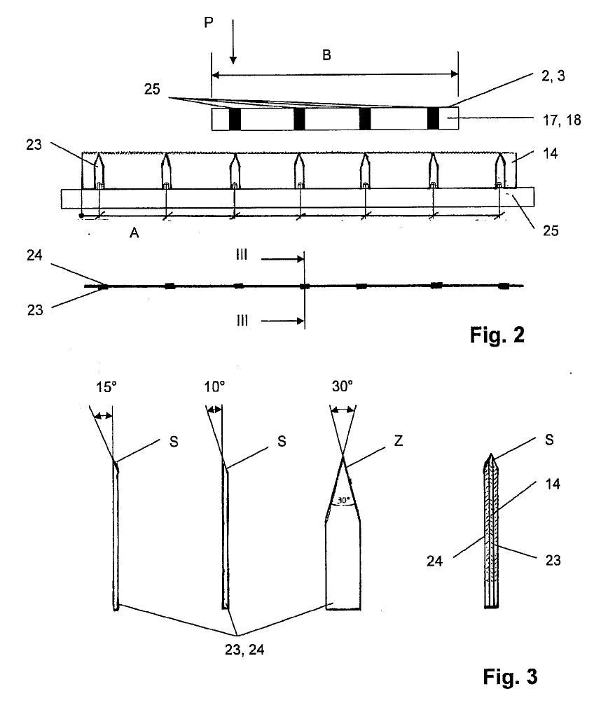

FIG. 2 shows a side view of a severing knife 14 of a device for cutting apart twin bag stacks, which may be integrated in a bag stack manufacturing machine. Shown above the severing knife 14 is an already severed bag stack 2, 3 with the top view of the end 17, 18 of the back wall 12, 13 with the heat seal points 16. Attached to the severing knife are seven strips 23, which are positioned at regular intervals A to one another. For reasons of clarity, only one strip 23 and one interval A have been labeled with reference characters. The bottom part of FIG. 2 shows a top view in the direction of the arrow P of the severing knife 14. Strips 23, 24 are attached to both sides of the severing knife 14. A mounting flange 25 located beneath the severing knife simultaneously carries a heater unit (not shown), by means of which the severing knife 14 and/or the strips 23, 24 can be heated. If only the mounting flange 25 is heated, then the severing knife 14 heats up, causing the strips 23, 24 to heat more intensely, since they are made of a material with a higher thermal conductivity. This temperature difference between the severing knife 14 and the strips 23, 24 is sufficient to heat-seal the bag stack 2, 3 in the regions 16 and also to cut apart the twin bag stack 1.

Visible in FIG. 3 is, firstly, the section along line III-III and, secondly, a top view of a strip 23, 24 as well as two different side views. As is evident from the section III-III, the strips 23, 24 are attached flat to the severing knife 14 and have a bevel that essentially corresponds to the bevel of the severing knife 14. FIG. 3 also shows a top view of a strip 23, 24, wherein the point Z provided on the strip 23, 24 is clearly visible and is specified as 30° by way of example. The two side views of the strip 23, 24 show the different design of the bevels S with 10° and 15°. It must also be noted here that the separation A between the strips averages approximately 100 mm. Preferably a separation A of 95 mm is set.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A bag stack comprising:
a plurality of connected bags made of a plastic film, each bag having a front wall and a back wall, the bag stack being heat-sealed at an end of the back wall; and
at least three heat seal points distributed across a width of the bag at the end of the back wall such that a stable bag stack edge is formed.

2. The bag stack according to claim 1, wherein the bag stack is heat-sealed at regular intervals on the end of the back wall.

3. The bag stack according to claim 1, wherein the outer heat seal points located on the bag stack edge are spaced away from the longitudinal sides of the bag.

4. The bag stack according to claim 1, wherein each bag of the bag stack is provided with suspension holes and/or predefined breaking points and/or bottom folds and/or side folds and/or flaps.

5. A device for use in a bag manufacturing machine, having at least one severing knife for cutting apart bag stacks, wherein the severing knife is movable relative to a twin bag stack, wherein strips made of a material with a higher thermal conductivity than the severing knife are attached to the severing knife at a distance from one another and on at least one side, and wherein the severing knife and/or each strip is heated.

6. The device according to claim 5, wherein the strips are made of copper.

7. The device according to claim 5, wherein the strips are designed with a point parallel to the severing knife and to the cutting edge of the severing knife.

8. The device according to claim 7, wherein the point has an angle of 30°.

9. The device according to claim 5, wherein the strips have a bevel substantially perpendicular to the severing knife and to the cutting edge of the severing knife so that a top end of the strip forms a bevel.

10. The device according to claim 9, wherein the bevel forms an angle of 10° to 15°.

11. The device according to claim 5, wherein the strips are attached to the severing knife at a distance from one another of approximately 100 mm, preferably 95 mm.

12. The bag stack according to claim 1, wherein the bags are for automatic dispensers.
